(19) United States
(12) Patent Application Publication
(10) Pub. No.: US 2024/0184114 A1
(43) Pub. Date: Jun. 6, 2024

(54) Method for securing a testing device

(71) Applicant: Intelligent Technologies International, Inc., Miami Beach, FL (US)

(72) Inventors: David S. Breed, Miami Beach, FL (US); Wendell C. Johnson, Katy, TX (US)

(73) Assignee: Intelligent Technologies International, Inc., Miami Beach, FL (US)

(21) Appl. No.: 18/436,392

(22) Filed: Feb. 8, 2024

Related U.S. Application Data
(63) Continuation of application No. 16/895,839, filed on Jun. 8, 2020, now abandoned.
Application No. 16/895,839 is a continuation-in-part of application No. 16/717,020, filed on Dec. 17, 2019, now abandoned.
Application No. 16/717,020 is a continuation-in-part of application No. 15/793,313, filed on Oct. 25, 2017, now Pat. No. 10,678,958.
Application No. 15/793,313 is a continuation-in-part of application No. 15/390,535, filed on Dec. 25, 2016, now abandoned.
(60) Provisional application No. 62/271,531, filed on Dec. 28, 2015.

(51) Int. Cl. G02B 27/01; G02B 27/00; G09B 7/07

(52) U.S. Cl. CPC G02B 27/0172; G02B 27/0093; G02B 27/0101; G02B 27/0176; G09B 7/07; G02B 2027/0138

(57) ABSTRACT

Method for securing against tampering a testing device that includes a frame operatively situated on a person's head, a display assembly on the frame, a processor that controls content of the display assembly, and a reflective assembly coupled to the processor and arranged on the frame in a position at least partly in front of the person's eyes when the frame is on their head and which allows viewing of the display assembly's content. A reflective optical element is integrated into the reflective assembly on an inner side and reflects display assembly content to the person's eyes. A chassis intrusion detection (CID) layer of a CID system that detects intrusion into the device is arranged on an outer side of the reflective assembly. The CID system provides notification of intrusion attempts into the reflective assembly to cause, when such notification is provided, a change in use of the device.

### CROSS REFERENCE TO RELATED APPLICATIONS

This application is a continuation of U.S. patent application Ser. No. 16/895,839 filed Jun. 8, 2020, which is:
a continuation-in-part (CIP) of U.S. patent application Ser. No. 16/717,020 filed Dec. 17, 2019, U.S. Pat. Appln. Publ. No. 20200118456, abandoned, and
a CIP of U.S. patent application Ser. No. 15/793,313 filed Oct. 25, 2017, now U.S. Pat. No. 10,678,958, which is a CIP of U.S. patent application Ser. No. 15/390,535 filed Dec. 25, 2016, abandoned, which published as U.S. Pat. Appln. Publ. No. 20170185805, and claims priority of U.S. provisional patent application 62/271,531 filed Dec. 28, 2015, expired, all of which are incorporated by reference herein.

This application is related to U.S. patent application Ser. No. 16/740,748 filed Jan. 13, 2020, which published as U.S. Pat. Appln. Publ. No. 20200152075, 16/564,905 filed Sep. 9, 2019, which published as U.S. Pat. Appln. Publ. No. 20190392724, 16/107,164 filed Aug. 21, 2018, which published as U.S. Pat. Appln. Publ. No. 20180357916, now U.S. Pat. No. 10,410,535, 15/964,208 filed Apr. 27, 2018, abandoned, which published as U.S. Pat. Appln. Publ. No. 20180247555, 15/467,733 filed Mar. 23, 2017, abandoned, which published as U.S. Pat. Appln. Publ. No. 20170193839, 15/329,243 filed Jan. 25, 2017, which published as U.S. Pat. No. 9,959,777, and 14/448,598 filed Jul. 31, 2014, which published as U.S. Pat. Appln. Publ. No. 20160035233, abandoned, and U.S. provisional patent application Ser. Nos. 62/040,806 filed Aug. 22, 2014, expired, 62/644,897 filed Mar. 19, 2018, now expired, and 62/668,965 filed May 9, 2018, expired, all of which are incorporated by reference herein.

### FIELD OF THE INVENTION

The present invention relates generally to the field of a computer-based system and method for taking a test while ensuring that the test-taker is not receiving assistance from another person or otherwise cheating while taking the test, and that a device used for displaying or taking the test has not been breached and is not being breached or otherwise compromised.

The present invention also relates generally to method for the production or manufacture of a system for performing secure testing which ensures that the test-taker using the system is not receiving assistance from another person or otherwise cheating while taking the test.

### BACKGROUND OF THE INVENTION

There is significant discussion over the past several years relating to MOOCs, Massive Open Online Courses. Using the Internet, education can be freely distributed to anyone who has Internet access. Mastery of almost any field taught in any schools including colleges and universities can be achieved by a motivated student without attending lectures at that college or university. Thus, technology is in place for a student to obtain, at virtually no cost, knowledge that has previously only been available to a campus-resident, matriculated student at a college, university or other institution.

In contrast, the cost of a traditional Massachusetts Institute of Technology (MIT) education, for example, resulting in a bachelor's degree can approach or exceed two hundred thousand dollars. A major impediment which exists from preventing a university such as MIT from granting a degree to an online-taught student is that the university needs to know with absolute certainty that the student did not cheat when taking various examinations required to demonstrate mastery of the coursework. With a degree from MIT, for example, industry will hire such a person at a starting salary approaching or exceeding $100,000 per year. Thus, the value to the student is enormous. Since the information which must be mastered is now available for free on the Internet, the main impediment separating a motivated and capable student from a high starting salary is that a degree-granting university must be certain that the student has demonstrated mastery of the material through successful completion of examinations without the assistance of a helper or consultant while taking the examinations.

Even when examinations are administered in a classroom, it is well known that extensive cheating can occur. In China, for example, where admission to college is solely determined by the score that a student receives on a one-time examination, motivation to cheat is enormous.

U.S. Pat. No. 5,565,316 (Kershaw et al.) describes a system and method for computer-based testing. A test development system produces a computerized test, and a test delivery system delivers the computerized test to an examinee's workstation. The method comprises producing a computerized test, delivering the computerized test to an examinee and recording examinee responses to questions presented to the examinee during the delivery of the computerized test. A method of delivering a computerized test is also provided in which a standardized test is created, an electronic form of the test is then prepared, the items of the test are presented to an examinee on a workstation display and the examinee's responses are accepted and recorded. A method of administering a computerized test is further provided in which a computerized test is installed on a workstation and then the delivery of the test to an examinee is initiated.

U.S. Pat. No. 5,915,973 (Hoehn-Saric et al.) describes a system for controlling administration of remotely proctored, secure examinations at a remote test station, and a method for administering examinations. The system includes a central station, a registration station and a remote testing station. The central station includes (a) storage device for storing data, including test question data and verified biometric data, and (b) a data processor, operably connected to the storage device, for comparing test-taker biometric data with stored, verified biometric data. The remote test station includes (a) a data processor, (b) a data storage device, operably connected to the data processor, for storing input data, (c) a biometric measurement device for inputting test-taker biometric data to the processor, (d) a display for displaying test question data, (e) an input for inputting test response data to the processor, (f) a recorder for recording proctoring data of a testing event, and (g) a communication link for communicating with the central station, for receiving test question data from the central station, and for communicating test-taker biometric data, test response data, and proctoring data to the central station. Verification of the test-taker and validation of the results are performed before or after the testing event.

U.S. Pat. No. 5,947,747 (Walker et al.) describes methods and apparatus for computer-based evaluation of a test-taker's performance with respect to selected comparative norms. The system includes a home testing computer for transmitting the test-taker's test results to a central computer which derives a performance assessment of the test-taker. The performance assessment can be standardized or customized, as well as relative or absolute. The transmitted test results reliably associate the student with his test results, using encoding, user identification, or corroborative techniques to deter fraud. For example, the system allows a parentally-controlled reward system such that children who reach specified objectives can claim an award that parents are confident was fairly and honestly earned without the parent being required to proctor the testing. Fraud, and the need for proctoring, is also deterred during multiple students testing via an option for simultaneous testing of geographically dispersed test-takers.

U.S. Pat. No. 7,069,586 (Winneg et al.) describes a method and system for securely executing an application on a computer system such that a user cannot access or view unauthorized content available on or accessible using the computer system. To securely execute the application, such method and system may terminate any unauthorized processes executing (i.e., running) on the computer system application prior to execution of the application, and may configure the application such that unauthorized content cannot be accessed, including configuring the application such that unauthorized processes cannot be initiated (i.e., launched) by the application. Further, such system and method terminates any unauthorized processes detected during execution of the application and disables any functions of the computer system that can access unauthorized content, including disabling any functions capable of initiating processes on the computer system. The application being securely executed may be any of a variety of types of applications, for example, an application for receiving answers to questions of an examination (i.e., an exam-taking application). Securely executing an application may be used for purposes, including to assist preventing students from cheating on exams, to assist preventing students from not paying attention in class, to assist preventing employees from wasting time at work, and to assist preventing children from viewing content that their parents deem inappropriate.

U.S. Pat. No. 7,257,557 (Hulick) describes a method, program and system for administering tests in a distributed data processing network in which predetermined test content and multimedia support material are combined into a single encrypted test file. The multimedia support may include visual and audio files for presenting test questions. The encrypted test file is exported to at least one remote test location. The test locations import and decrypt the encrypted test file and load the test content and multimedia support material into a local database. The test is administered on client workstations at the testing location, wherein the test may include audio questions and verbal responses by participants. During testing, biometric data about test participants is recorded and associated with the test files and participant identification. After the test is completed, the completed test results, including verbal responses and biometric data, are combined into a single encrypted results file exported to a remote evaluation location. The evaluation location imports and decrypts the encrypted results file and loads the test results into a local database for grading.

U.S. Pat. Appln. Publ. No. 2007/0117083 (Winneg et al.) describes systems, methods and apparatus for remotely monitoring examinations. Examinations are authored and rules are attributed to the exams that determine how the exams are to be administered. Proctors monitor exam takers from remote locations by receiving data indicative of the environment in which the exam takers are completing the exams. A remote exam monitoring device captures video, audio and/or authentication data and transmits the data to a remote proctor and data analysis system.

U.S. Pat. No. 10,359,647 (Vasiliev et al.) and U.S. Pat. Appln. Publ. No. 20200050023 (Vasiliev et al.) assigned to iGlass Technology, Inc. utilize electrochromic technology to control transmission of light from the environment to the eyes of the wearer for the purpose, among others, of preventing an observer other than the wearer from observing the contents of the display. No provision is made for preventing the observer from physically removing a portion of the electrochromic layer to provide a window through the electrochromic layer thus exposing access to a projected display if present and allowing placement of a camera, for example, that can observe the display contents and supply that information to a consultant assisting the student in taking the test.

Despite these and other patents and applications that describe methods of preventing cheating on examinations, a brief Google search reveals that cheating on examinations is prevalent worldwide. Thus, these inventions have not been successful in eliminating cheating on examinations. For example, recently students taking examinations for credit in connection with MOOCs have found that they can register many times for a course, and collect and combine the results of multiple simultaneous examinations to compose a single correctly answered test for submission for credit. This is known as Cameo cheating.

The following companies provide proctor services during exam/tests:
ProctorU
https://www.proctoru.com/
Kryterion—acquired by Pearson in 2015
https://www.onlineproctoring.com/Examity
http://examity.com/
Pearson Vue—both online proctored test and a network of physical test centers
https://home.pearsonvue.com/
Proctorio
https://proctorio.com
B Virtual Inc.
https://bvirtualinc.com/
Question Mark Online Proctoring
https://www.questionmark.com/content/online-proctoring-service

These companies have a similar sequence of the services provided: proctor identifies test-taker person (using test-taker's passport or any other documents); proctor continues to observe the testing session (all sessions are video recorded, desktop of the test-taker computer will be also recorded); and proctor checks the test-taker during the test (it can be made in a way of questioning the test-taker or audio signals that ring at certain times).

According to the presentation of Kryterion company: “ . . . After the proctor verifies that your ID matches your image appearing on their web camera, they will ask you to answer a few security questions. These will further ensure that the correct person is taking the exam.”

So, basically, ‘cheating’ means receiving test answers while proctor observes test-taker sitting in front of the computer.

Cheating consists of two stages: interception of unique test questions and receiving answers to test questions. Receiving answers can be much easier for a cheating test-taker than intercepting information from a company that sent special tests to the examinee.

Online proctored testing (almost all the above-mentioned companies) allow test-takers to take and pass exams from their homes. This fact increases the possibility of cheating.

Receiving answers which won't be noticed by proctors can be done by the following ways: answers are provided on a tablet or a smartphone located behind (or near) the monitor; projection of the answers to any surface (wall, screen, etc.) behind the monitor as illustrated below (FIG. 1); using a compact Morse code transmitter by touching the skin of the test-taker; a micro-earpiece located in the ear, vibrations in the seat, a bone speaker attached to the student's shoulder or neck (or other bone) underneath clothes, etc.

Question interception can be achieved by hidden micro cameras (located in the wall or on the test-taker's clothes) which capture the monitor screen with answer choices and sends it to test-taker's consultant. Alternatively, it can be achieved by a transmitter which captures video signals from the system to the monitor, and located in conjunction with monitor wires, and then transmitted to the consultant.

To summarize, there are many ways that a consultant can obtain a copy of the questions on an examination and transmit the answers to the test taker that are not and cannot be detected by proctoring services.

As generally used herein, a “test” is any type of question-based application that requires analysis by a person taking the test and a response from this person. A test may therefore be considered an examination, a quiz, an assessment, an evaluation, a trial and/or an analysis.

### OBJECTS AND SUMMARY OF THE INVENTION

The present invention is directed at addressing and ideally solving the problem of guaranteeing with high certainty that a student taking a test is acting alone without the aid of a consultant or other helper or otherwise cheating.

A method for securing a testing device against tampering in accordance with the invention is particularly applicable to a testing device including a frame configured to be situated on a person's head, a display assembly on the frame, a processor in the frame that controls content of the display assembly, and a reflective assembly coupled to the processor and arranged on the frame in a position at least partly in front of right and left eyes of the person when the frame is on the person's head and configured to allow viewing by the person of content on the display assembly.

The method entails integrating into the reflective assembly a reflective optical element on an inner side that reflects content of the display assembly to the person's eyes when the frame is on the person's head, arranging a chassis intrusion detection (CID) layer of a CID system that detects intrusion into the device on an outer side of the reflective assembly, and providing from the CID system notification of intrusion attempts into the reflective assembly to cause, when such notification is provided, a change in use of the device.

The reflective assembly can be connected to the processor using a flex ribbon circuit. The flex ribbon circuit preferably includes a ribbon having plastic layers and electrical conductors between the plastic layers and that terminate at a first set of electrical contacts. The processor may be arranged or mounted on a printed circuit board that includes a second set of electrical contacts attached to the first set of electrical contacts. The CID system can be provided with layers having an array of conductors and that are attached to one another and to the ribbon to enclose the processor. Breakage of a conductor in the array of conductors is detected by the processor and causes the notification of an intrusion attempt into the processor.

The reflective optical element may be a first, inwardmost layer that is reflective. Light transmission through the reflective assembly can then be controlled by means of a second intermediate layer outward of the first layer. The second intermediate layer is a liquid crystal layer or an electrochromic light control layer. The second layer can have a state wherein all light is prevented from passing through the reflective assembly to thereby provide a blocking state to the reflective assembly, or a state wherein at least some light is prevented from passing through the reflective assembly thereby enabling simultaneous viewing of an environment in front of the person and content on the display assembly. The processor may be coupled to the second layer to control light transmission provided by the second layer. The CID layer can be configured as a third, outwardmost layer that covers the second layer and provides notification of intrusion attempts into the second layer. The processor is then coupled to the third layer to detect attempts to access the second layer and affects functionality of the device when an attempt to access the second layer is detected.

A device in accordance with the invention includes a frame configured to be situated on a person's head, a display assembly on the frame and a combiner assembly arranged on the fame in a position at least partly in front of right and left eyes of the person and which allows simultaneous viewing by the person of an environment in front of the person and content on the display assembly. The combiner assembly includes a first, inwardmost layer that is reflective and reflects content of the display assembly to the person's eyes when the frame is on the person's head, a second intermediate layer outward of the first layer and that controls light transmission through the combiner assembly (a blocking film), and a third, outwardmost layer that covers the second layer and provides notification of intrusion attempts into the second layer.

The display assembly has a first display portion and a second display portion and the combiner assembly has a first combiner portion associated with the first display portion to enable a left eye of the person to view the first display portion via the first combiner portion and a second combiner portion associated with the second display portion to enable a right eye of the person to view the second display portion via the second combiner portion. The first and second combiner portions may be integral with and horizontally alongside one another. A processor in the frame controls content of the display assembly, and is able to alternately block the first and second combiner portions. The processor is thus coupled to the second layer to control light transmission provided by the second layer and also may be coupled to the third layer to detect attempts to access the second layer and affects functionality of the device when an attempt to access the second layer is detected.

The combiner assembly has lateral edges spaced apart from respective lateral sides of the frame to form gaps between the combiner assembly and the frame alongside the eyes of the person when the frame is on the person's head.

At least one camera may be provided on a part of the frame below the combiner assembly and operatively obtains images of one or both eyes of the person. The obtained images are used for biometric identification purposes and to monitor viewing by the person when the frame is on the person's head.

Another embodiment of the device has a multi-layered structure of the combiner assembly as a preferred embodiment and includes a frame, a display assembly on the frame, and the combiner assembly. At least one camera is provided on a part of the frame below the combiner assembly and operatively obtains images of one or both eyes of the person. The obtained images are used for biometric identification purposes and to monitor viewing by the person when the frame is on the person's head. The same variants described in the preceding embodiment may be present in this embodiment as well.

### BRIEF DESCRIPTION OF THE DRAWINGS

The following drawings are illustrative of embodiments of the system developed or adapted using the teachings of at least one of the embodiments disclosed herein and are not meant to limit the scope of the disclosure as encompassed by the claims.

FIG. 1 illustrates possible cheating methods used by test-taker.

FIGS. 2 and 3 show forward and back views of a monitor device of the invention.

FIG. 4 is a chassis intrusion detector design and its assembly sequence.

FIG. 5 shows the unassembled monitor housing.

FIG. 6 shows the chassis intrusion detector operating principle.

FIGS. 7A, 7B, 7C, 7D, 7E and 7F illustrate a preferred design of the monitor for two eyes utilizing a single display.

FIGS. 8A, 8B, 8C, 8D, 8E, 8F, 8G, 8H and 81 illustrate a preferred design of the monitor for two eyes utilizing a two large displays.

FIGS. 9A, 9B, 9C and 9D illustrate the device of FIG. 8 with the chassis intrusion detector installed.

FIG. 10 illustrates a combiner assembly with a chassis intrusion detector (CID) and blocking film.

FIG. 11 illustrates a flex circuit connector cable passing through the CID joint to connect to a circuit on a printed circuit board.

FIG. 12 illustrates the use of light from a display to illuminate an iris of a person wearing the device.

### DETAILED DESCRIPTION OF THE INVENTION

### Administration and System Operation

A primary concept of the present invention is that a student located anywhere in the world ought to be able to obtain a degree from any college or university or other institution, provided the student can prove that he or she has mastered the coursework. Proof often comes from the student passing a series of examinations. Since the student can be located anywhere in the world, it can be impractical for that student to travel to a particular place in order to take an examination.

A secondary concept of the present disclosure is to permit a classroom full of students to take a test without cheating. Consider for example, the test required for college entrance. Normally the SAT must be taken at an approved location where the test taking can be monitored by proctors. Cheating can still occur in that situation as has been vividly pointed out in recent cheating expose's which have dominated the news in 2019, where proctors gave out the test questions prior to the exam in one case and altered the exam answers in other cases. Using the system described herein, an SAT or GRE can be taken anyplace without concern that the student may be cheating. Thus, a student does not need to travel to an approved location, but can take the SAT from his home, or other convenient location, which can be anywhere in the world. Additionally, many colleges and universities as well as US based companies require foreign born applicants to pass an English proficiency test, the TOEFL. In order to minimize the cost of taking such a test, a student or other person can take this test anywhere with the full assurance that he or she did not cheat.

Hiring organizations do not always care where the person has acquired the expertise if they can be confident that the student has done so. As an employer, for example, a manager does not care as much whether a person graduated from Harvard or MIT as he/she does whether the prospective employee has mastered the coursework. On the other hand, having a degree listed on a person's resume can greatly affect the person's opportunities for employment throughout his or her lifetime. In the United States, however, colleges and universities have become unreasonably expensive, especially when consideration is given to the fact that for the most prestigious schools, the student usually is required to reside on or near the campus. This residency requirement has little to do with his or her mastery of physics, engineering or other scientific or non-scientific subjects, but handicaps an otherwise qualified student from job opportunities and lifetime earnings.

A student can typically learn the coursework on his or her own and in fact, studies have shown that for many students attending class is largely a waste of time. Over the Internet, a student can be exposed to the best teachers providing well constituted lectures, textbooks and other coursework. If this is done with many students, the cost per student is minimal. What is needed, however, is a method of verifying that a student has mastered the subject matter through taking and passing examinations over the Internet or in a classroom, and without cheating and at minimal cost to the institution.

A further advantage of the secure test system described herein is that it permits the standardization of courses and tests. Thus, student who chooses such standardized courses can study those courses from any college or University that meets the standard. A particular course, for example, may not be offered from a particular University during a particular semester and thus the student would be free to take that equivalent course from another college or University and since the tests would be standardized the credits can be honored by any University where the student eventually wishes to obtain his or her degree. Thus, degrees become more portable and their acquisition more suitable to people who may live at various locations during the time of the college or university experience.

An objective of the present invention is therefore to provide a system that can ascertain the identity of a test-taker with certainty and that cheating has not occurred during test-taking. Prior to discussing how these goals are achieved, an understanding of the cheating prevention process needs to begin with an analysis of the flow of information from the test-providing institution to the student's eyes.

For now, assume that the test is a multiple-choice test or one where the answer is in the form of a number. The institution can randomize the questions and answers of a test so that no student will take the same test with the same order of the questions or answers. Therefore, knowing the answers provided by one student cannot help another student. As a result, the answers which are sent back to the test-provider do not need to be encrypted, except where added security is desired that the answers have not been altered by the test providing company or the college or university as explained below.

The questions making up the test, however, do need to be encrypted and careful attention needs to be paid to where the decryption process occurs and to the protection of the private key which performs the decryption and the process by which it is generated. For example, if the decryption occurs in an unprotected computer, then two problems arise. First, the decrypted test can be captured, and a copy sent to a computer in another room, for example, or the private key can be copied, and a second computer can simultaneously decrypt the test. Once the test can be viewed by a consultant who is not seen by a proctoring system, the consultant can transmit answers to the test-taker by a countless number of methods facilitating cheating.

Consider how the consultant might conduct this transmission to the test-taker. Perhaps, the consultant is in an adjoining room and transmits answers using RF communication to a device hidden on the body of the test-taker which retransmits to a receiver pressed against a part of the test-taker's shoulder or head, hidden by his or her hair or clothing, or mounted on his or her teeth. Such devices are readily available. RF frequencies used can be chosen to be undetectable by any device designed to detect such transmissions since the range of frequencies available span more than 6 orders of magnitude and, in addition, frequency hopping techniques can be used. An RF sensor mounted anywhere cannot pickup such transmissions without knowing the transmitted frequency and coding scheme.

Even if the consultant is in another country, if he or she can see the test, there is no way to prevent transmission of answers to the test-taker. Other methods include vibrators in the seat, wires attached to head-mounted speakers, etc. The consultant can even project the answers onto a portion of the room ceiling, walls or floor which is not covered by room monitoring cameras but observable by the test-taker and can even alternate such locations to fool systems that monitor the test-taker's behavior. Basically, there is no method of preventing the consultant from communicating answers to the test-taker and therefore, it is necessary to prevent the consultant from obtaining a copy of the test questions.

If the questions are decrypted on an ordinary computer, then many potential information leakage problems exist. Regardless of the operating system, if the consultant can obtain access to the processor board of the computer, then the connector that connects to the display can be removed and reconnected to a splitter inserted in such a manner that the display operation is unaffected but a second set of wires are now available which contain the display information. These wires can be connected to a small processor which connects them to a transmitter to send the display information to another room by undetectable RF. Alternately, a simple wire can be used, hidden from view of whatever monitoring cameras are present.

Another approach is to steal the private key which cannot be protected in an arbitrary computer. Once the consultant has the key, he or she can intercept the transmissions to the computer and decode the test in a second computer. A conclusion is that the private key, and/or the code used to generate the key, must be stored and the decryption process undertaken in a special protected device discussed below.

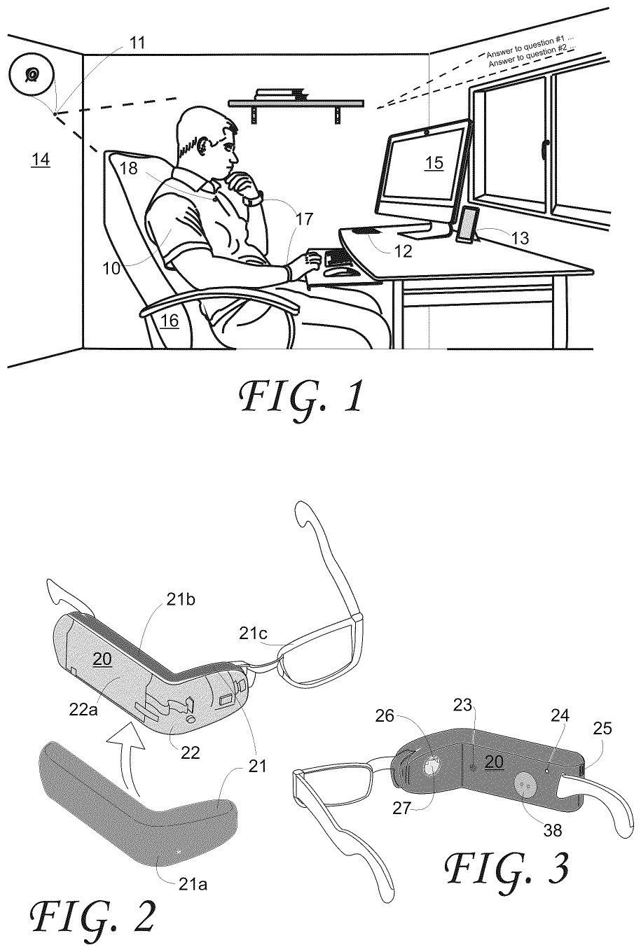

Consider now the display. If there is a display where the questions can be seen from anywhere other than the eyes of the test-taker, then there is another path for leakage of test questions. If decryption occurs right at the display and the display is protected from tampering, the display itself can facilitate transmission of the test questions. A camera looking through an undetectable port in a wall, see FIG. 1, or undetectably worn by the test-taker, can capture the image of the test questions and transmit this to a consultant by any number of methods. Thus, either the display must be scrambled, so that only the test-taker wearing special glasses can see the questions, or the display must be so close to the test-taker's eyes that no one else can get close enough to see it. The second of these approaches will be discussed below. A conclusion is that no ordinary display or ordinary computer is usable without incurring a risk of cheating.

Some methods for accomplishing the objective of cheating prevention which have been considered include using one or more cameras to image a substantial portion of the space around the test-taker so that a consultant (or other person aiding the test-taker) cannot be located in a position where he or she can influence the test-taker without being seen by a camera. A structure has been proposed such that the computer on which the test is being taken will not be accessible by another computer in another room, for example, where a consultant can simultaneously view the exam and communicate answers to the test-taker. If this structure is separated from the display and if the display is not scrambled or very close to the test-taker's eyes, this approach can be easily defeated. Also, it is not required that the consultant be where he or she can be observed by any cameras.

Similarly, it has been proposed that a microphone is preferably available to monitor the audio environment where test-taking is occurring to prevent audio communication with the test-taker by a consultant. A microphone will not pick up communications from the consultant in the form of RF communications translated into sound at the head, for example. The microphone will pick up any oral communications from the test-taker and thus it can be a necessary part of the system to detect if the test-taker is orally reading the questions to a consultant. To make sure that the microphone has been activated, a speaker or other sound source may be necessary to periodically create a sound which can be sensed by the microphone. Otherwise, the test-taker can cover the microphone or otherwise render it useless. An alternative or complementary approach, as described below, can make use of a contact microphone pressed against the skin or a facial bone, e.g., cheek bone, of the test-taker which will pick up sound emanating from the mouth of the test-taker but not be heard by the audio microphone. An audio microphone detects sound from the environment in addition to that from the test-taker. These sounds can drown out or otherwise prevent the microphone from picking up the test-taker from softly speaking into a hidden microphone that communicates with a remote consultant. These and other methods and apparatus are discussed below but already it has become evident that the apparatus used to take the test must be especially designed to solve the issues mentioned above.

The identity of the test-taker must be known and can be ascertained using one or more of a variety of biometric sensors and systems such as a palm, fingerprint, heartbeat shape, iris, retinal or other scan, a voiceprint, or a good image of the test-taker coupled with facial recognition as further discussed below. For the purposes of the present invention, the primary biometric identification system will rely on the use of a small camera which has been designed to periodically image the test-taker's iris, retina or portion of the test-taker's face as discussed below.

When taking a test, the student can go through a process which sets up the apparatus and validates its operation. The student can then confirm his identity which will have been previously established and stored locally or remotely for comparison. The process of ascertaining the identity can be recorded for later validation. Output from the various monitoring systems can be fed to one or more pattern recognition systems, such as trained neural networks, which have demonstrated a high accuracy.

Each time the student takes one or more tests and thus demonstrates his or her mastery of the coursework (by passing), he or she can be awarded credits and after enough credits have been obtained, he or she can be awarded a degree. After the degree award, the student would then presumably begin working for a company, government agency, or other organization and the system should periodically be verified through consultations or surveys with the management of the organization to ascertain that the hiring organization is satisfied with the proficiency of the student derived from the online courses. This feedback allows for continuous improvement of the overall educational and testing process and system.

The degree-granting institution will incur costs during this process and some payment from the student to the institution may be considered. Depending on the circumstances, this payment can be a charge per course, per test or per degree. Since the earning power of the student can be significantly increased, and out-of-pocket cost to the institution is small, these payments can be postponed until the student is being paid by a hiring organization and, in fact, such an organization may be willing to cover these payments. In any event, the payment should be relatively small when compared to the typical cost of a traditional college education. However, the degree-granting institution by this method, can greatly expand the number of degrees granted and thus, although the payment per student will be small, the total sum earned by the institution can be substantial.

A good review of the state of higher education in the United States and of the rise of MOOCs can be found in the Nicholas Carr's article on the subject as published in the MIT technology review. The article can be found on the following Internet website. http://www.technologyreview.com/featuredstory/429376/the-crisis-in-higher-education/. Quoting from this article “Machine learning may, for instance, pave the way for an automated system to detect cheating in online classes, a challenge that is becoming more pressing as universities consider granting certificates or even credits to students who complete MOOCs.” It is an objective of this invention to respond to the mentioned challenge.

As discussed in numerous places in the literature, there is a significant difference in the complexity of evaluating a student's proficiency through tests which can be machine graded depending on the course subject matter. For those math and science courses where a numerical answer is to be derived, machine evaluation of the test is relatively simple. However, for those disciplines where a reasoning or writing skill or an artistic or mechanical skill is evaluated, there is great controversy as to whether this can be done by machine testing. This issue will be addressed below although more research and innovation in this area is necessary.

It is not an objective of this invention to determine how a test should measure a student's proficiency nor how it should be graded. A primary objective here is to provide confidence to the degree-granting institution that the student who is taking a test is in fact the student who has registered for the course and that the student is acting alone without the aid of a consultant who may be remote or nearby. This assurance should be provided with a probability of cheating reduced to on the order of one in 100,000 and, similarly, the false accusation that cheating is taking place reduced to a similar probability.

When a student decides to enroll in a degree program, for example, or even to enroll in a course for which he or she desires credit, the first step will generally be to register with the organization, typically a college or university, and to establish the beginning of the student's record. During this registration process, for the case where the student intends to get credit for one or more courses taken online, the student will be required to submit various types of information which will permit the student to be identified positively over the Internet. Although there may be no charge for taking the course, there will generally be some charges related to the test-taking and administration of the student's program. In a preferred embodiment of this invention, a specially configured device will be loaned or sold to the student to be used for test-taking.

When the student registers at a school, he or she will be generally required to submit a picture that will become part of his or her record. Later, when taking a test for the first time using the monitor (the generic name for the test taking devices disclosed herein), another picture may be required so that the student can be properly associated with a public key, derived from his or her iris code, which can be part of his student ID. A second picture of the student may be required on registration while wearing the monitor. This is as a second check that the student in the school picture is the one wearing the monitor when the iris-based public key ID was created. In fact, to assure the maximum integrity, every person that registers with a college can be required to provide a picture which will be linked with his or her iris code and thus to his or her transcript. A student with the wrong iris code would then not have his transcript updated. Also, a prospective employer who receives a transcript also can get a picture which should match the person being hired. If the registration is done online, the laptop webcam can be used. If a student cheats by having a consultant take his or her tests, the transcript will not match the proper iris code and either the transcript will not be updated, or the transcript picture will not match the person.

Wearable glasses which meet the objects of this invention are described below and are configured so that all the functions necessary to identify the student and significantly reduce the opportunity for cheating are incorporated within the glasses design, hereinafter called the “Monitor”. At the end of the course, or when the student completes his relationship with the institution, he or she may be required to return the Monitor; however since in some implementations the Monitor may be linked to the student's biometric-based identification, the biometrics stored on the device, if any, would need to be erased or overwritten by those of another student (described below). In one method, a cryptographic key set used for decrypting a test is created based on one or more biometric measurements each time the student puts on the Monitor. In this case, one Monitor can be used for any number of students and a student can use any Monitor. In this case, the student's biometrics, or data derived therefrom, can only be stored on the Monitor while it is in use by the student and can be erased when the student removes the Monitor. This also removes biometric privacy concerns. In some implementations, due to the cost and computational complexity of the software, the biometric, such as the iris scan, can be sent to an internet server and converted into a unique code which is then returned to the Monitor. In this latter case the iris image can be erased from the server.

Since the value of a degree from a prestigious institution can be immense, the motivation to cheat when taking a test can be enormous. An industry of consultants now exists for aiding students in cheating when taking tests and thus obtaining a degree. This invention, where it is used, will prevent the success of such consultants and thus assure the integrity of an earned degree.

If a student, when taking a test, is inclined to cheat, this inclination can be facilitated if a helper or consultant has access to the display which shows the test while it is being taken. If the consultant has such access, then he or she will use a communication method where he or she can transfer information to the test-taking student in a manner that cannot be detected. This invention is intended to reduce and ideally eliminate the opportunity of the consultant from observing the display or otherwise learning the content of the test questions and therefore of being able to derive and communicate answers to the test-taker.

If the student were to use his or her private computer for displaying a test, it would be generally relatively easy for a consultant to attach a second remote monitor which would display the same information as the primary monitor. There exists software, for example, which permits someone who is even located remotely from a particular computer to observe the display of that computer. Alternatively, if the student or his consultant has access to the ports and operating system of the computer upon which the student takes tests, access to the information on the display is relatively simple to achieve. One method of preventing this is to design a device which prevents other computers from connecting with the device in such a manner that the display can be copied. Thus, in a preferred implementation of the invention, a special device, and in particular a wearable glasses type device, herein called the Monitor, has been configured and provided to the student for those cases where the student desires credit for the course he or she is taking.

### Basic Monitor Embodiment

FIG. 1 illustrates a student 10 taking an examination using any one of various proctoring systems such as Examine or Proctor U. The student 10 can get help when answering examination questions if his/her consultant has access to these questions. This access can be accomplished in many ways such as through a hidden camera 11 which can be embedded in a wall 14 facing a computer screen 15 used for administering the test, hidden on the student 10 and looking through a hole in the student's shirt 18 or embedded in a piece of jewelry 17, or, most easily, a transmitter can be built into the computer which transmits the contents of the display to the consultant in another room or in another country via the Internet. The consultant can be a person who already knows the material being tested or he or she can query the internet for the answer.

Since the consultant can see the questions, there are countless ways that answers can be communicated to the student 10 such as by projecting them on the floor, a wall or ceiling, placing a bone speaker in the student's seat 16 where it will contact the student's spine or on his/her shoulder under his/her clothes, for example. Even tying a string around the toe of the student 10 and pulling three times for answer c can work. Broadcasting answers can be provided by smartphone 12 or tablet 13 behind the computer monitor 15. None of these methods, and countless others, can generally be detected by an online proctor if the device is out of the proctor's view. It is thus not possible to prevent a consultant from communicating with the test-taker, leaving the only remedy left of preventing the consultant from knowing the test questions.

Of course, other methods are available such as bribing the proctor or someone that can provide a copy in advance of the test questions and answers. Prevention of these methods will be discussed below. Since cheating is easily accomplished using all known proctoring or other anti-cheating methods, there is an urgent need for a system that cannot be defeated. Until that is available, granting of meaningful credit for online education is not possible.

A device constructed in accordance with the teachings of this invention is illustrated in FIGS. 2 and 3 which are a perspective views of a head-worn glasses type device, generally referred to as a monitor 20, containing an electronics assembly (PCB) 22a with several sensors, cameras and a display all protected with a chassis intrusion detector 22 (CID) prepared using teachings herein. Chassis intrusion detector 22, and other chassis intrusion detectors disclosed herein, is also referred to as a chassis intrusion detection system or CID system herein.

FIGS. 2 and 3 are views from the front and rear respectively showing the device or monitor 20 which comprises three main parts: plastic housing parts 21a and 21b (collectively referred to as a housing 21) and internal PCB parts covered by chassis intrusion detector 22 (CID) to be described in more detail below. Housing part 21a serves as a cover. Housing part 21b extends from an eyeglass frame 21c. Housing part 21b can be substantially L-shaped with a first portion extending straight outward from an edge of the frame 21c and second portion substantially perpendicular to the first portion and positioned in front of the frame 21c. The frame 21c has a lens portion including an aperture for receiving an optional see-through lens (prescription or plain glass) and a support portion extending rearward from the lens portion. The support portion may be two temples as shown, or an elastic headband as described below. Monitor 20 includes a cross-view camera 23, microphone 24, and a contact microphone 38 (FIG. 3).

To further discourage cheating, if the test-providing institution is providing tests to 1000 test-takers either simultaneously or at different times, and if the test is of a multiple-choice type and contains fifty questions, the order of the questions and of the answer selections can be scrambled and thus different for each test provided. Since this provides a very large number of different tests each containing the same questions, there is little risk that answers from one set of questions can be of any value to a test-taker taking a different ordered set of the same questions.

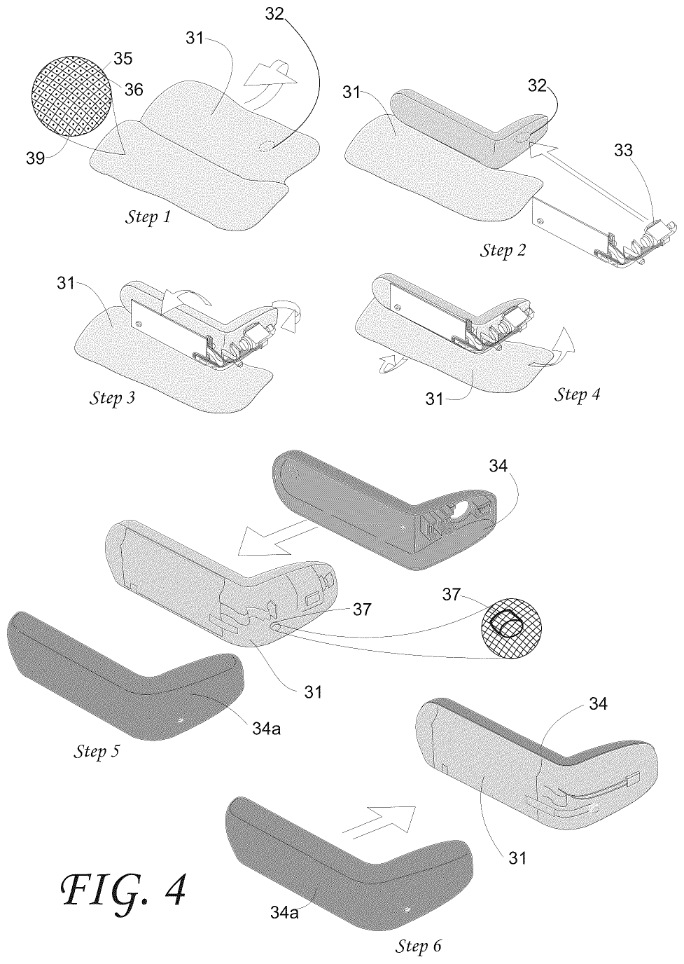

The entire electronics package of the device 20 (FIGS. 2 and 3) is encapsulated in a thin film 31 (FIG. 4) called a chassis intrusion detector (CID). As described above and below, an array of wires can be printed onto a plastic film encapsulating the electronics package, including the display and cameras, in housing 21 such that any attempt to break into the housing 21 will sever one or more of the wires.

The CID can comprise a thin clear polyimide film upon which is placed a thin copper trace. In one implementation, the copper trace can be about 0.002 inches wide on about 0.010-inch centers. Thus, about 80% of the film is not covered by the copper traces allowing for light to pass through. The thickness of the copper trace can be about 5 microns to about 25 microns.

The trace can begin and end each at a pad each about 0.010 inch in diameter which can have metal on both sides of the film allowing for connections to the electronic circuits for the case where the CID covers such circuits.

A private key, or the code for generating such a key as explained in more detail below, for decoding the test questions and any other commands sent by the test-providing institution can be held in volatile RAM memory in, for example, housing 21. This can be kept alive through an extended life (10 years) battery which also can be recharged when the monitor 20 is connected to a power supply (not shown) through connector 25. If the chassis intrusion detector 22 detects an attempt to break into the housing 21, then power to the RAM memory can be shut off and the private key and any other private information or algorithms will be erased. Other techniques to disable the operability of the monitor 20 for a test as a result of the detected attempt to break into the housing 21 are also possible, either alternative to or additional to the erasure of the private key.

When the test-taker is preparing to take a test, he or she will place the monitor 20 onto his or her head. An image will be acquired of the iris, retina, or other biometrics by camera 26 and sent to a server via a secure telecommunications network and/or the Internet. The server will convert the iris image to a code and return the code to the monitor. Using a secret and proprietary algorithm resident in the monitor, the monitor can convert the code from the server to a cryptographic key set and return the public key to the server. The server can then associate and store the public key with the student's ID. At the completion of this process, test questions will be transmitted to the monitor 20 encrypted with the student's public key, decrypted by the monitor using the student's private key and displayed on the display 27, for example, one at a time.

The private key development algorithm can be held in the CID volatile ROM memory and placed thereon during monitor manufacture after the CID has covered the electronics, display and sensors of the monitor. This algorithm is erased if power is lost to the ROM or RAM memory such as will happen if a wire making up the CID is cut as entry is attempted. The algorithm can comprise any of many functions which are known to those skilled in the art which can create a unique cryptographic key set based on an iris code in a manner which cannot be duplicated without knowledge of the algorithm. The algorithm is kept secure by the monitor supplier and is only released in conjunction with the manufacture of a monitor. Once on a monitor it cannot be retrieved and any attempt to do so will cause it to be erased. Thus, the key generation algorithm cannot be duplicated on any other device.

The iris camera 26 is controlled to periodically check to ascertain that the test-taker's iris is present and that it has not changed. This is controlled by the processor on PCB 22a in the monitor 20. If anything anomalous occurs, such as the absence of an iris or eyeball or the change of position of the iris or eyeball, then the display 27 will be deactivated by the processor. Thus, when the test-taker removes the monitor 20, the display 27 will automatically stop displaying test questions. Similarly, if the test-taker transfers the monitor 20 to another person whose iris does not match that of the test-taker, then the display 27 will not show test questions. Above and in what follows, the iris will be used to represent any of the aforementioned biometric scans observable by camera 26.

When the test-taker has completed answering the test questions, he or she can indicate such through the mouse, keyboard, orally, or gesture (user interface) and the display 27 will no longer display test questions. The remainder of the interaction with the test-providing facility can then occur as described below.

A forward-looking camera can have a field of view (FOV) of about 120° or, alternatively, more than one camera each with a lesser FOV view can be provided. If more than one camera is used, a larger FOV even exceeding 180 degrees can be obtained. This FOV will cover the hands of the test-taker to check for the case where the test-taker is typing in the questions on a keyboard where they are transmitted to a consultant. If the hands of the test-taker cannot be seen by the forward-looking camera, the display 27 will be turned off until the hands can be seen. If this happens frequently, the test can be terminated. The forward-looking camera can also be used to check for the existence of other devices near the test-taker. These devices may include a tablet or other computer, a smart phone, books or papers, displays, or any other information source, including notes projected onto the ceiling, wall or floor, which is not permitted to be used for the particular test. If the test is an open book test, then use of some of the above-listed objects can be permitted. Software which accomplishes these pattern recognition tasks can utilize one or more trained neural networks.

The test-taker may have enabled a hidden switch which disconnects the keyboard when a keyboard is allowed, from the monitor 20 and connects it to a consultant thereby enabling the test-taker to send test information to the consultant. The forward-looking camera can determine that the test-taker is typing, and the processor can ascertain that the monitor 20 is not receiving the typed information and indicate a fault. For most tests, a keyboard will not be necessary and thus it can be eliminated from the setup to minimize its use for consultant communication. As described below, a virtual keyboard can be provided when typing is required.

A limited number of encrypted commands which relate to the test being administered can be transmitted with the encrypted test from the test-providing institution or test administrating facility. These commands control some aspects of the test-taking process such as whether it is an open book or closed book examination, whether it is a timed test and if so, how much time is allowed, how many restarts are permitted, how many pauses are permitted etc. Since the test process is controlled by the monitor 20, these commands will be decrypted and used to guide the test-taking process by the monitor 20.

A schematic of the operation of the chassis intrusion detector 22 is provided in FIG. 4. Since the chassis intrusion detector 22 is designed to encompass the entire electronics and sensors assembly, it must be relatively thin so as not to interfere with the contact microphone 38, microphone 24 and speaker or sound creator 28 and be transparent such as to not interfere with the display 27 or camera 26.

The CID 22 (FIG. 2) is a thin film which wraps around the PCB 22a and other parts. It can be made from a single sheet folded over and then glued together. It must conform closely to the camera 26 and display lenses so as not to distort the images. A wire to the USB connector 25 will be very thin where it goes through the CID 22. Connector 25 can snap into a holder built into the housing 21.

A preferred construction, as illustrated in FIG. 4, is to provide a single film layer (film 31) comprising a labyrinth of wires 35, 36 which are very narrow and closely spaced such that any attempt to penetrate the film 31 will cause one or more of these wires 35, 36 to be cut. The base film 31 can be made from polyimide onto which is printed the electric wires 35, 36. The final assembly is covered with a thin coating to insulate the wires 35, 36. A microprocessor (not shown) monitors the total resistance, inductance and/or mutual inductance of a circuit including the wires 35, 36 and erases the private information if there is a significant change in these measurements, e.g., above a threshold. Since any attempt to break into the electronic and sensor assembly will necessarily sever one of these wires 35, 36, this design provides an easily detectable method of determining an attempt to intrude into the system electronics and sensor assembly.

CID 22 has following properties:

The wires 35, 36 can go along both sides of the film (FIG. 4). They can be run one way on one side and cross at right angles on the other side. Alternately, a wire can be printed only on one side of the film.

The wires 35, 36 on one side can be connected to those on the other side by plated through holes so that there can be one continuous circuit. Alternately, the wires can be arranged so that there are multiple circuits which can be connected together in parallel to form more than one circuit each of which is separately monitored or the total impedance of the separate branches can be added together and the sum monitored. By this method, the total resistance of a branch can be kept within easily measurable bounds. Normally, the wire width is kept small so as not to interfere with the passage of light where the CID 22 covers displays and cameras. If the resistance gets too high, the wires can be made wider at locations where they do not cover cameras or displays.

On the underside near the mating socket in the PCB 22a, the wires 35, 36 can get wider (˜200 microns) so that a 2-pin connector can be attached.

The CID 22 can have very small holes 39 (about 50 to about 100 microns diameter) located in the centers between the wires 35, 36, or alongside of wires when only one side has wires, to allow it to breathe to prevent the buildup of heat from the electronics.

Assembly procedure may comprise the following steps (FIG. 4):
Step 1: prepare to wrap film 31 constituting the CID 22 around PCB 22a.
Step 2: wrap CID 22 over the PCB 22a. A critical step here is the attachment of the CID 22 to a display lens 33. Circle 32 can be a marked location on the CID 22 opposite the position of display lens 33. Circle 32 can be glued to the display lens 33.
Steps 3, 4: after gluing the PCB assembly, plug the CID 22 into the PCB 22a and wrap the rest of CID 22. Now, the PCB 22a is fully covered by the film 31 to form the CID 22.
Step 5: insert PCB 22 in housing 34; forward looking camera 37 and cross view camera are covered by the film 31 of the CID 22.
Step 6: Snap housing part 34a (like housing part 21a) into the housing 34 (like housing part 21b).

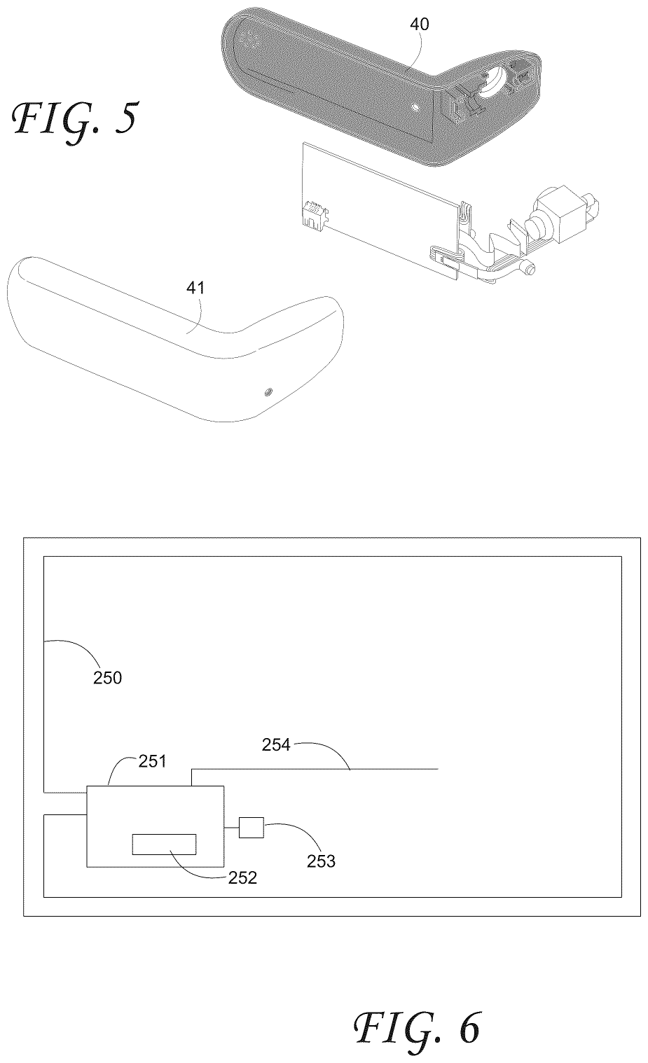

FIG. 5 shows the unassembled device housing: rear housing part 40 and front housing part 41 which are similar to housing parts 21b, 21a, respectively.

FIG. 6 illustrates that the chassis intrusion detector (CID) can contain its own microprocessor security assembly 251, containing the circuit property monitoring processor and battery 253, or they can be located on the PCB 22a. The CID 22 can also contain its own RAM memory 252. The RAM memory 252 can contain the private key and/or key generating code and other private information which is kept alive and thus usable by the battery 253. The battery 253 is chosen such that it can provide enough power to maintain the RAM memory 252 active for several years and also provide power to the microprocessor security assembly 251 to monitor the wire labyrinth. The conductive wire is attached to the microprocessor which checks, for example, the resistance or impedance of the wire. Any change in resistance or impedance detected by the microprocessor is indicative of an attempt to intrude into the interior of the electronics and sensors assembly. If such intrusion is detected, power is removed from the RAM memory 252 and the private information is erased.

Power may be supplied from an external computer though connection 254 leading to the USB connector 25 of FIG. 3. Connection wire 254 also provides communication from the electronics and sensors assembly of which the security assembly is a part. The fine wire maze is shown at 250. Security assembly (SA) 251 can be a separate subassembly which is further protected by being potted with a material such that any attempt to obtain access to the wires connecting the battery 253 to the microprocessor and to the RAM memory 252 would be broken during such an attempt. This is a secondary precaution since penetration to the SA 251 should not be possible without destroying the private information.

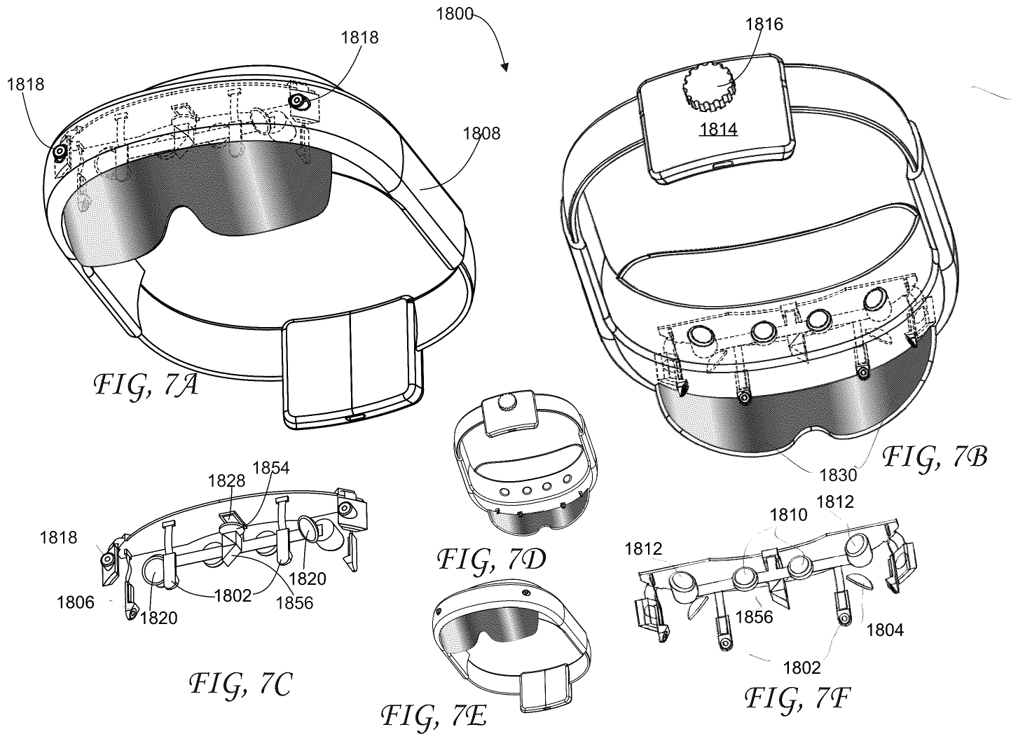

An alternate monitor design which provides an image to both eyes using a single microdisplay is illustrated in FIGS. 7A-7F. In this design the components, which must be protected by the CID not shown, are more closely arranged to simplify the CID design. A single microdisplay 1828 is used to illuminate the lenses 1830 seen by each eye. Two iris cameras 1802, two crossview cameras 1806, and two forward cameras 1818 can be implemented in this design. Since the display will be seen by both eyes, both must be monitored to guarantee that the device has not been rotated or in some manner pulled away from either eye to permit a foreign camera to be inserted. The crossview cameras 1806 similarly must now watch both sides of the test-taker's head to search for nefarious cameras inserted by the test-taker.

Sensor assemblies 1810 and 1812 are provided on each side of the forehead (see FIG. 7F). These sensor assemblies 1810, 1812 measure the EKG and sound emitted by the test-taker's head. Sensor assembly 1810, for example, can contain a contact speaker and contact microphone, one in each sensor. Similarly, sensor assembly 1812 can contain an ECG (EKG) sensor. The contact microphone will determine when the test-taker is emitting sounds and the contact speaker will be used to test that the contact microphone is in contact with the test-taker's skin, as described in the previous monitor examples. The contact speaker can also emit an audio sound and thus can be used to test the audio microphone, not shown, if present.

Since the EKG sensor pads must be sensitive to very low voltages, they generally will be placed on the outside of the CID. A small pair of contacts can be placed in the CID to permit signals to be passed from the EKG sensors to the interior electronics. Other methods of transferring information from outside the CID to inside are discussed below. The EKG sensor pads can be appropriately attached to the CID by gluing in such a manner that any attempt to remove the EKG pads will destroy the CID. Two or more forward or front view cameras 1818 are provided in order to increase the field of view of the sensor system and to permit future 3D images to be created when augmented reality is implemented into this design. Although not shown, the optical system can be arranged such that alternately polarized frames can be fed to the right and left eyes of the test-taker wherein the single display panel can pass the information to the eyes to permit 3D holographic viewing by selectively polarizing successive frames or even in the same frame.

Additional biometric checks can be implemented using the forward-facing camera including finger prints and palm vein prints.

The monitor in this example contains a headband 1808 with an adjustment knob 1816 to permit the apparatus to the securely mounted to the test-taker's head (see FIG. 7B). As an alternate to the adjustment knob 1816, a ratchet arrangement can be provided which allows one side of the headband to be inserted into the other and pushed together until the proper fitting has been obtained. A battery 1814 can also be integrated with the device and placed at the rear of the device to balance the forces from the monitor on the head of the test-taker. In this manner the center of gravity of the monitor can be adjusted to be placed near the center of the test-taker's head. Under these circumstances there should be little tendency for the monitor to slip forward or backward. The battery 1814 now can be considerably larger than in previous designs and designed to provide many hours of operation without an external power source. A wire, not shown, can lead from the battery to a wall charger or, alternately, a receptacle can be provided in the battery case for that purpose.

The display panel 1828 projects downward through lenses 1854 to a polarizing beamsplitter and mirror assembly 1856 which sends alternately polarized light to the left and to the right. Thus, the display image is split into two images alternately polarized. The birdbath mirrors 1820 then project the light down toward the lenses, or combiners, 1830 which contain reflecting surfaces and reflect the light into the eyes. Each lens can be differently polarized so that the light which is polarized horizontally for the right eye, for example, interacts with a vertically polarized film on the right lens. This has the effect of making the right lens act as a mirror preventing the image from being seen from in front of the monitor. Similarly, the polarized image for the left eye which can be polarized vertically, for example, would interact with a horizontally polarized film for the left eye. Rather than polarizing vertically and horizontally, naturally polarized light from the environment will have less effect if the polarization angles are +45 degrees and −45 degrees.

In an alternate arrangement, not shown, the light from the projectors will project to the rear of the device to locations on either side of the head where a mirror, such as a birdbath mirror would change the direction of the image and project it toward the polarized lenses for viewing by the test-taker. This method simplifies the design of the lenses eliminating the need for reflective surfaces to change the angle of the light to be integrated into the lenses.

Several adjustments which are not shown will now be described. An adjustment of the projector angles, or the mirrors that reflect the image to the lenses, can be used to accurately aim the reflections into the test-taker's eyes thereby accommodating any variance in the Inter pupil distance for different people. The lenses can be a compound lens arrangement whereby the outer lens corrects for prescription lens as needed for people with different requirements. The inner lens can be the one from which the reflections to the eyes are made. These two sets of lenses can be designed so that the outer lenses are interchangeable depending on the visual needs of the test-taker. The inner lens can be incorporated within the CID thus eliminating the possibility of a test-taker placing a camera that could see the inner lens and thus the display. The focus of the display can be changed by moving the various optical components. Under this arrangement the field of view can be controlled so that it can only be seen by the test-taker's eyes.

In this monitor design, provision can be made for augmented reality devices such as a virtual smartphone, mouse or keyboard for use by the test-taker. These can require that the fingers of the test-taker be recognized and mapped in such a way that the motion of the fingers can be accurately tracked and understood. The virtual keyboard can be attached to a location near the test-taker's fingers or to a table that is either virtual or appears in the environment.

The arrangement in this design also lends itself for holographic presentations.

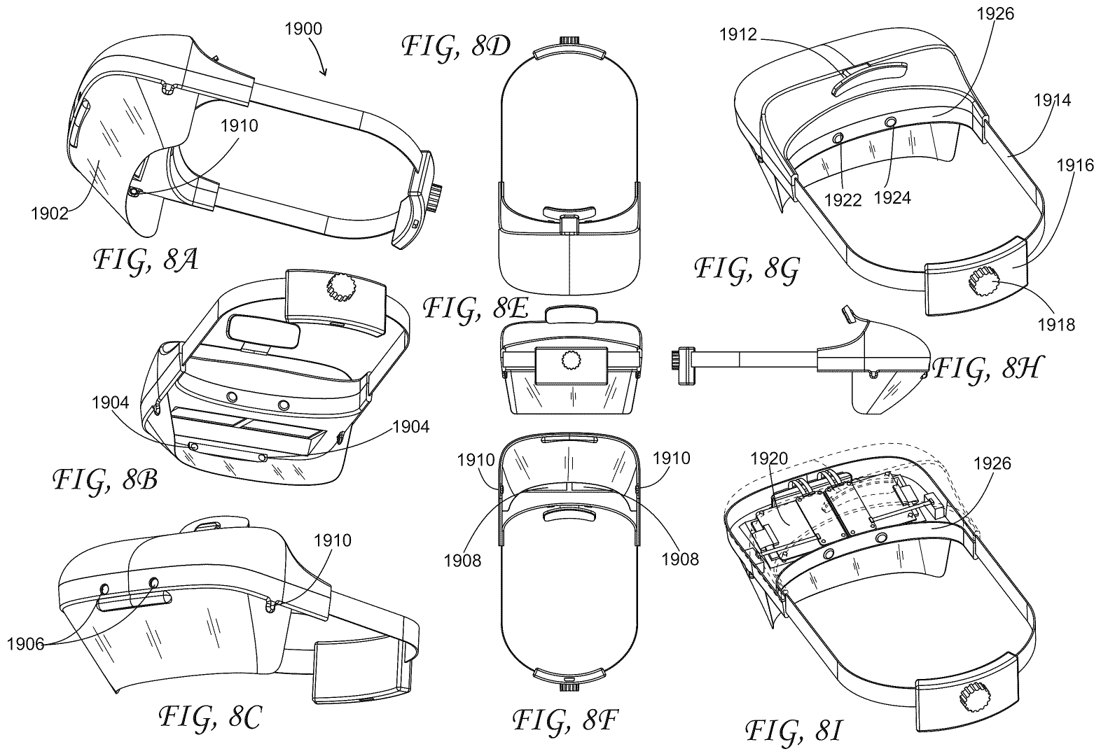

FIGS. 8A-81 illustrate another preferred design of a monitor 1900 for two eyes, in this case utilizing two larger displays 1908 forming a display section in a housing of the monitor 1900. Two displays 1908 are positioned approximately horizontally in the monitor 1900 alongside one another as shown in FIG. 8F. Images from the displays 1908 reflect off one or more combiner 1902. Each combiner 1902 preferably has a semi-reflective coating on the inside surface, i.e., that surface in the optical path between the display 1908 and the eyes of the test-taker, which reflects only a percentage, for example 50%, of the incident light from the displays 1908 toward the test-taker's eyes. The balance of the light is passed vertically downward.

Each combiner 1902 allows the test-taker to simultaneously view the environment, since the combiner 1902 is positioned on the frame or housing of the monitor 1900 to be in front of the test-taker's eyes when the monitor 1900 is on the test-taker's head, as well as the reflection from the displays 1908. The combiner 1902 therefore does not block out all of the light from the environment in front of the test-taker, in contrast to some virtual reality goggles that entirely cover the eyes of the wearer and prevent the wearer from seeing outside of the device. Also, the combiner 1902 does not have to contact or conform to the shape of the wearer's face at the bottom edge and so there is often a gap between the bottom edge of the combiner 1902 and the person's face.

The combiner 1902 preferably generally has an antireflective coating on the outside surface to potentially allow the maximum light to pass through the combiner 1902 from the environment. The combiner 1902 can also have a privacy film which prevents light from being seen from outside except in a direction approximately perpendicular to the surface of the combiner 1902. Such a film thus blocks the light which normally passes through the combiner 1902 in the vertical direction and could thus otherwise be seen from below. The combiner 1902 represents a singular combiner or multiple combiners that cooperate to provide the functionality described above. An upper edge region of the combiner 1902 is attached to the frame or housing of the monitor 1900 so that the combiner 1902 is below the frame. Also, the combiner 1902 and frame or housing are components of a front portion of the monitor 1900. The edges of the front portion are not configured to conform to the face of a wearer. In addition to a front portion designed to be at least partly in front of the eyes of the test-taker when the monitor 1900 is on the test-taker's head, the combiner 1902 may also be provided with side sections, one on each side of the front section. As such, the person can see in front of them or to the sides only through the combiner 1902 and its associated structure.

The displays 1908 themselves can also have privacy films attached to their surfaces to accurately direct the light in a direction perpendicular to the display surface making it difficult to see the display from below. Privacy films generally work best in preventing light transmission in the horizontal or vertical directions and therefore two such films may be required for the displays 1908. The combiner 1902 can also comprise a film of electrochromic or liquid crystal material whose transmissivity can be electrically controlled. Thus, the amount of light passing through the combiner 1902 from the environment can thus be controlled. This permits the view of the reflected image from the combiners 1902 under conditions of bright ambient light. Alternates to electrochromic and liquid crystal materials include Kerr cells. Finally, as discussed below, the crossview cameras 1910 are provided to monitor the space surrounding and below the combiner to search for unwanted cameras.

Two iris cameras 1904 are provided to monitor the irises of the test-taker to make sure that the eyes of the test-taker are in the proper position during test-taking while the display is illuminated, and the monitor 1900 is on the test-taker's head. The cameras 1904 are also used for biometric identification purposes. The iris cameras 1904 can have a much wider field of view (FOV) than necessary to observe the iris and thus they can also be used to monitor for hidden cameras placed by a test-taker to transfer the contents of the test to an accomplice. The iris cameras 1904 can have associated infrared (IR) or white light LEDs to illuminate the irises. White light LEDs can be annoying to the test-taker and IR LEDs can potentially cause eye damage. The displays, on the other hand, can provide sufficient light, especially when a white display is shown, to adequately illuminate the irises for identification purposes. This is illustrated in FIG. 12 wherein light from display(s) 2010 reflects off on combiner 2012 illuminating the eye 2014 which can be observed by camera 2016 situated at the bottom of the combiner 2012.

Iris cameras 1904 are part of an iris camera system arranged on the frame of the monitor 1900 and which is generally configured to image the left and right eyes of the test-taker when the monitor 1900 is on the test-taker's head. The iris camera system may include a different number of iris cameras 1904, so long as the left and right eyes are imaged. The iris camera system is arranged on the front portion of the monitor 1900.

Crossview cameras 1910 are provided to monitor the volume between the displays, combiner and eyes of the test-taker to check for the placement of hidden cameras intended to transfer the contents of the test to an accomplice. Through the use of the iris and crossview cameras 1904, 1910, it should not be possible to hide an imaging device within the volume encompassed by the monitor 1900 and the face of the test taker.

Crossview cameras 1910 are part of a crossview camera system arranged on the frame of the monitor 1900 and which is generally configured to image from a location on a first lateral side of the frame toward a second lateral side of the frame opposite the first lateral side and below the combiner, and image from a location on the second lateral side of the frame toward the first lateral side of the frame and below the combiner when the monitor 1900 is on the test-taker's head. The crossview camera system may include a different number of crossview cameras 1910, so long as the volume encompassed by the monitor 1900 and the face of the test-taker is imaged. The crossview camera system is arranged on the front portion of the monitor 1900.

Two forward-looking cameras 1906 are also provided for monitoring the environment surrounding the monitor 1900 and test taker. These cameras 1906, which together will encompass a large field of view, can be used to monitor for the existence of notes, textbooks, or other apparatus which could aid the test-taker in answering the test questions, but which are prohibited by the rules of the test. The existence of a computer which the test-taker could use to access the Internet can be determined. Similarly, if the test-taker is typing on a keyboard, that action can be detected. In short, the forward-looking cameras 1906 can detect any forbidden activity undertaken by the test-taker. They can also determine the presence of potential accomplices trying to help the test-taker during the test-taking process. The forward cameras 1906 can be provided with LED or other illumination which can be in the visual or infrared (IR) portion of the electromagnetic spectrum. The cameras 1906 need to be sensitive to IR if IR illumination is used.

Forward-looking cameras 1906 are part of a forward looking camera system arranged on the frame of the monitor 1900 and which is generally configured to image an area in front of the frame, and ideally to the outward sides of the frame when the monitor 1900 is on the test-taker's head. The forward looking camera system may include a different number of forward looking cameras 1906, so long as the environment around the monitor 1900 is imaged. The forward looking camera system is arranged on the front portion of the monitor 1900.

The images obtained by the six cameras discussed above, can be analyzed using trained neural networks or Deep Learning technology, for example.

The monitor is held in position on the test-taker head by means of forehead resting pad 1912 coupled with a band 1914 which is adjustable for tension by adjustment knob 1918 or by a ratcheting system discussed above. Another band 1926, which holds the contact microphone 1922 and contact speaker 1924 in position against the forehead of the test-taker, also contributes to the proper positioning of the monitor on the head of the test-taker.

The electronic printed circuit boards are illustrated generally at 1920 and are powered by a battery 1916 through wires which are not illustrated or through connection to a wall or other power source.

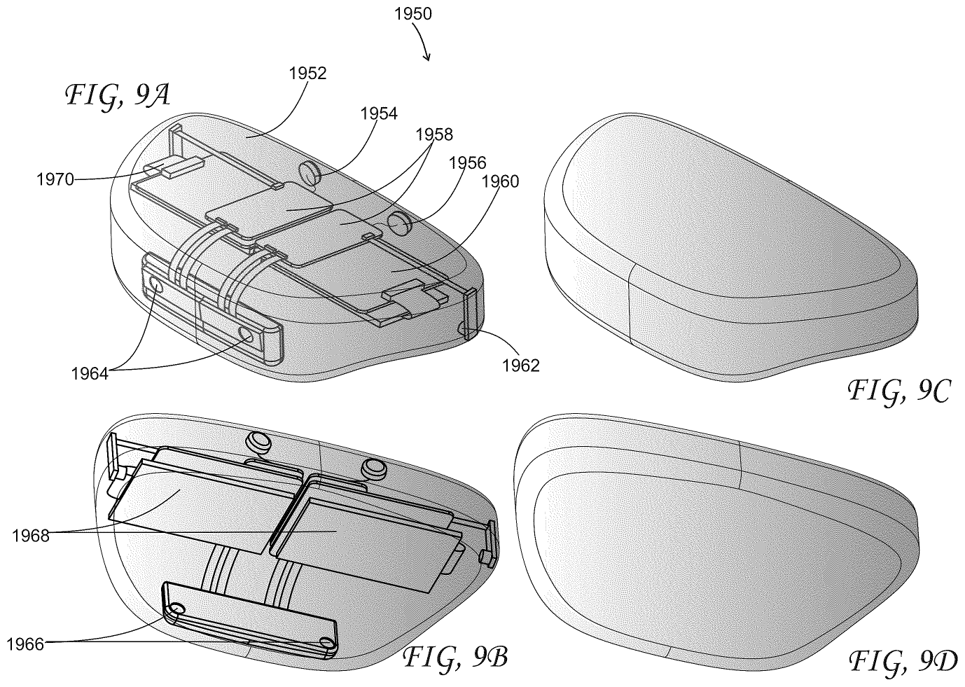

FIGS. 9A-9D illustrate key components of the device when covered with the chassis intrusion detector (CID). The operation of the CID is discussed in detail elsewhere, including in applications incorporated by reference herein, and will not be repeated here. The assembly covered by the CID is shown generally at 1950.

In FIGS. 9A-9D, 1952 represents the CID, 1954 is the contact microphone and 1956 is the contact speaker, 1958 represents interfaces between forward cameras 1964 and iris cameras 1966 with a PC board 1960, and 1962 represents the cross-view cameras 1968 represents displays connected to the PCB board 1960 by ribbon cables 1970.

The CID 1952 is represented by a smooth envelope. In practice, the CID 1952 will adhere to the surfaces of the various components. In some cases, it will be necessary to add additional structure to position the CID 1952 properly relative to the various components it is meant to protect. The CID 1952 may be attached directly to one or more of the cameras 1962, 1964, 1966 and displays 1968 in such a way as to provide a smooth surface that does not distort the images being acquired or displayed by these devices. Naturally, other configurations are possible whereby the CID 1952 adheres more closely to the PCB 1960 and some of the components such as the contact microphone 1956, speaker 1954, and various cameras 1962, 1964, 1966 are outside of the CID 1952. In this case, the passthroughs of the various wires become a concern as discussed below.

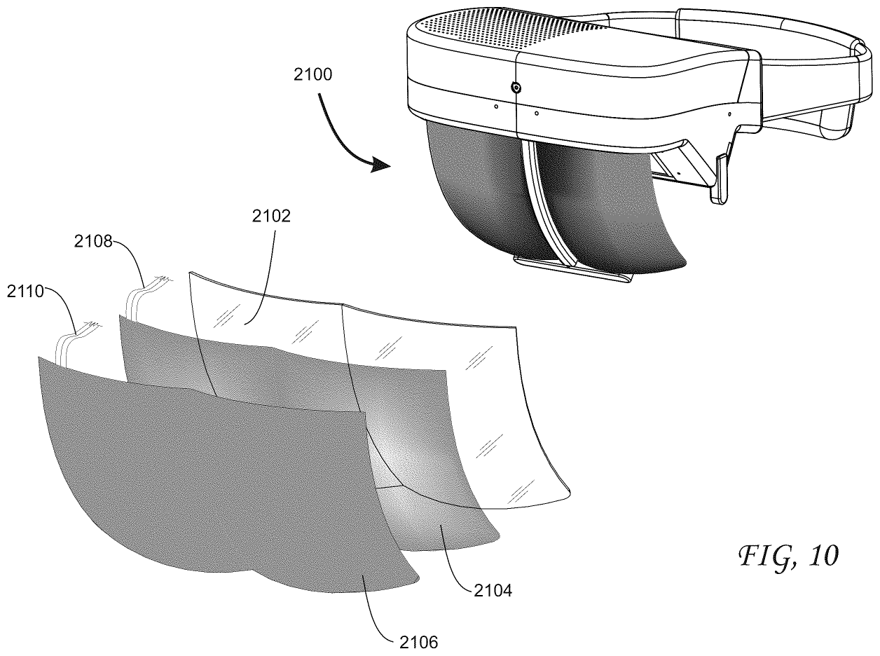

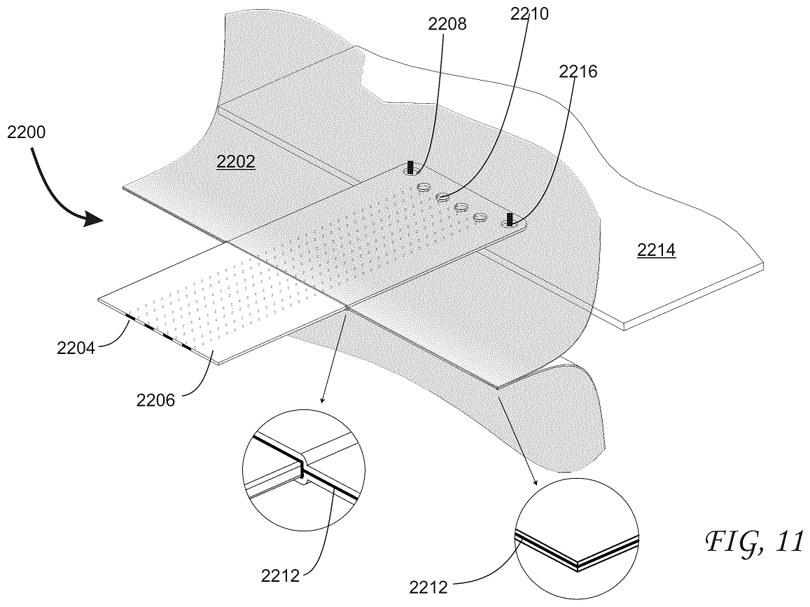

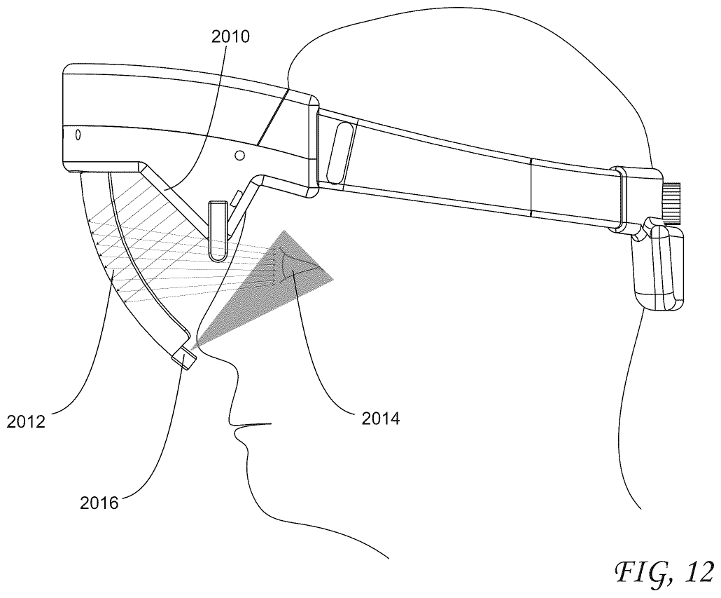

FIG. 10 illustrates another implementation of the monitor in accordance with the invention using a combiner assembly shown generally at 2100. The combiner assembly 2100 can comprise two portions, one associated with each eye, and with each combiner section including at least 3 layers. The combiner portions may be integral with and horizontally alongside one another. The combiner assembly 2100 has lateral edges spaced apart from respective lateral sides of the frame of the device to form gaps between the combiner assembly 2100 and the frame alongside the eyes of the person when the frame is on the person's head.

Each combiner portion has a multi-layered or multi-film construction, which may be the same for both or different.

Preferably, an inwardmost layer 2102 of the reflective optical element is a reflective lens which reflects light from the display(s) to the eyes of the test-taker, also referred to as a display assembly. The reflective optical element, comprising the three layers described below, may be integrated into the reflective assembly. The reflective lens only partly reflects the images to be displayed (and to be viewed) by the person wearing the device. Intermediate layer 2104 of the reflective optical element can be an electrochromic or liquid crystal light control layer which controls transmission of light through the combiner assembly 2100. This can be called a blocking film. In the case of the liquid crystal implementation, the amount of light allowed to pass through the layer 2104 can vary from near 0% to about 50%. When it is electrically set at about 50%, the wearer, whether a test-taker or otherwise, can see the environment in front which is useful for augmented reality applications. However, anyone standing in front of the wearer can also see what is displayed on the combiner assembly 2100 and thus the test questions when the wearer is in a test-taking mode. The writing will be reversed so the observer will need a mirror to be able to read the text or it can be captured by a camera and processed by a computer. For the test-taking mode, therefore, the transmissivity can be set to near 0% blocking the transmission of the test questions through the combiner assembly 2100.

The liquid crystal implementation of the blocking film is commonly used in glasses designed for viewing 3D See for example TV. See for example https://www.amazon.com/gp/product/B0833W9QQJ/ref=ppx_yo_dt_b_asin_title_008_s00?ie=UTF8&ps c=1. In this case, the right and left lenses, also referred to as display portions of the display assembly, are alternately turned into a blocking and non-blocking modes synchronized with a signal emitted from a specially designed TV. The electrochromic implementation is described in U.S. Pat. No. 10,359,647 (Vasiliev) discussed above.

If access to the blocking film, intermediate layer 2104, is accessible, a portion of the blocking film can be removed opening a window in the blocking film for the placement of a camera, for example, to capture the test questions. To eliminate this possibility, the blocking film can be covered with a CID 2106, an outwardmost layer of the reflective optical element, the nature of which is discussed above. The blocking film and the CID 2106 can be connected to the electronics PCB (processor in the frame) which is done by, for example, wires shown generally at 2108 and 2110. The wires 2108, 2110 used can be in the form of flex circuits as will be discussed below. This processor controls content of the display assembly, and can direct the blocking film to alternately block the two combiner sections or more generally control light transmission provided by the blocking film. The same processor could also detect attempts to access the blocking film and affect functionality of the combiner assembly 2100 or device when an attempt to access the blocking film is detected.

One or two cameras, not shown, can be used to monitor the blocking film to make sure that it has not been disabled. When blocking is on, for example during test-taking, the blocking film, i.e., intermediate layer 2104, should be opaque. This can be seen by camera(s) placed above or alongside of the display(s) facing the combiner assembly 2100. The display assembly can momentarily display a coded image which can then been seen by the camera(s) and a comparison made. If the test fails, the display can be turned off. FIG. 12 shows a camera 2016 situated at the bottom of the combiner assembly which can be used in the embodiment of FIG. 10, e.g., mounted on a support structure of or coupled to the frame that extends between the right and left combiner portions and has a bottom section below the right and left combiner portions. One or more such cameras 2016 may be provided on the frame to image one or both eyes of the person when the frame is on their head, with the images being used for biometric identification purposes and/or to monitor the viewing direction of the person. The lowest edge of the part of the frame on which the camera 2016 is situated, or the lowest edge of the combiner assembly if there is no part of the device underneath it, is not intended to be against the wearer's face when the frame is worn, as are virtual reality headsets which seek to block all ambient light. Rather, there is a space below and on the sides of the combiner assembly and the wearer's face to provide the device with an open configuration (as opposed to the closed configuration of virtual reality headsets).

The CID 2106 can also be used in other modes such as to cover a keyboard or mouse making them unhackable.

The blocking film, i.e., intermediate layer 2104, can also be extended beyond the combiner assembly 2100 to block visual access to other paths where light from the display(s) could leak.

The liquid crystal version of the blocking film, i.e., intermediate layer 2104, can be switched in a small fraction of a second and thus by controlling the ratio of on-to-off time, it can be used to dim the light coming from the environment as a sort of sunglasses. An ambient light sensor can be added to control the amount of dimming.

A flex ribbon circuit is illustrated passing through a CID joint generally at 2200 in FIG. 11. Ribbon 2206 of this flex ribbon circuit can be about 10 mm wide, about 130 microns thick with, for example, about 18-micron thick by about 1 mm wide conductors 2204 sandwiched between two layers of polyimide with appropriate adhesive layers. The ribbons of the flex circuit 2206 can be bonded using adhesive 2212 to the CID layers 2202. The conductors terminate at solder pads 2210. During assembly, the flex circuit is placed over pins 2208, 2216 in the printed circuit board 2214 where the solder pads on the flex circuit line up with solder pads 2210 on the printed circuit board, not shown. Heat is then applied with an air gun, for example, and the solder pads 2210 melt and attach to each other making the appropriate connections to the printed circuit board 2214. After all the flex circuits are attached to the PCB 2214, the edges of the CID layers 2202 are bonded together and to the flex circuits 2206. When the process in completed, it will not be possible to penetrate the CID without breaking one or more wires in the CID which then erases the contents of the RAM.

### SUMMARY

A substantial number of sensors have been introduced, each of these sensors requires at least one algorithm to assess sensor output and determine whether the test-taker is cheating or not. Since the Monitor is provided with a chassis intrusion detector (CID), it is virtually impossible for a consultant to modify the apparatus to transmit the display information to another room, for example. With a CID, there are no accessible wires which connect the display to the electronics package, for example. A second CID protects the combiner from optical intrusion.

Finally, the display itself is protected. The test-taker can wear a camera which has a lens the size of a small pea but for that camera to see the display, it will also be seen by the iris imager or the eye-to-display crossview cameras since there is a very limited viewing area for the camera to see the display.

Some important features of this invention differentiate it significantly from prior art attempts to develop secure testing systems. These include:

A wide field of view optical system with protection from an outsider viewing the test when it is in progress but allowing for a view of the environment and the development of augmented displays which are believed to be useful with future teaching strategies.

Apparatus and a method for attaching devices external of the protected electronics package while maintaining the maximum security.

Using liquid crystal technology, the view through the combiner can be blocked adding to the security of the secure test-taking apparatus and method. In this case, the liquid crystal blocking film can be turned totally black or opaque by a control mechanism so that the contents of the display cannot be seen from a person standing in front of the test-taker.

Other methods can be used with the monitor to permit the test-taker to enter commands to the monitor. One such method using the iris camera is track the motion of the eye which is usable to select answers to the questions or to control the operation of the monitor. Eye blinking and time or duration of closing also can be used for this purpose. Another such method is to use gestures which can be seen by the forward-facing camera and interpreted by appropriate software. Teeth clicking, for example, can be used for controlling the test and for choosing various of the multiple choices for a test question.

Method for taking tests and administering tests using the monitors described above are also considered to be part of the invention. Methods for ensuring a test-taker is not cheating also considered to be part of the invention. Although the monitors described herein are for particular use for test-taking, they are not limited to such use and other uses for the monitors, e.g., gaming, are also considered as being part of the invention.

Finally, all patents, patent application publications and non-patent material identified above are incorporated by reference herein. The features disclosed in this material may be used in the invention to the extent possible.

Although several preferred embodiments are illustrated and described above, there are possible combinations using other geometries, sensors, materials and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A method for securing a testing device against tampering, the testing device including a frame configured to be situated on a person's head, a display assembly on the frame, a processor in the frame that controls content of the display assembly, and a reflective assembly coupled to the processor and arranged on the frame in a position at least partly in front of right and left eyes of the person when the frame is on the person's head and configured to allow viewing by the person of content on the display assembly, the method comprising:
integrating into the reflective assembly a reflective optical element on an inner side that reflects content of the display assembly to the person's eyes when the frame is on the person's head;
arranging a chassis intrusion detection (CID) layer of a CID system that detects intrusion into the device on an outer side of the reflective assembly; and
providing from the CID system notification of intrusion attempts into the reflective assembly to cause, when such notification is provided, a change in use of the device.

2. The method of claim 1, further comprising connecting the reflective assembly to the processor using a flex ribbon circuit.

3. The method of claim 2, wherein the flex ribbon circuit comprises a ribbon having plastic layers and electrical conductors between the plastic layers and that terminate at a first set of electrical contacts.

4. The method of claim 3, further comprising arranging the processor on a printed circuit board that includes a second set of electrical contacts attached to the first set of electrical contacts.

5. The method of claim 3, further comprising providing the CID system with layers having an array of conductors and that are attached to one another and to the ribbon to enclose the processor, whereby breakage of a conductor in the array of conductors is detected by the processor and causes the notification of an intrusion attempt into the processor.

6. The method of claim 1, wherein the reflective optical element is a first, inwardmost layer that is reflective.

7. The method of claim 6, further comprising controlling light transmission through the reflective assembly by means of a second intermediate layer outward of the first layer.

8. The method of claim 7, wherein the second intermediate layer is a liquid crystal layer.

9. The method of claim 7, wherein the second intermediate layer is an electrochromic light control layer.

10. The method of claim 7, further comprising configuring the second layer to have a state wherein all light is prevented from passing through the reflective assembly to thereby provide a blocking state to the reflective assembly.

11. The method of claim 7, further comprising configuring the second layer to have a state wherein at least some light is prevented from passing through the reflective assembly thereby enabling simultaneous viewing of an environment in front of the person and content on the display assembly.

12. The method of claim 7, further comprising coupling the processor to the second layer to control light transmission provided by the second layer.

13. The method of claim 12, further comprising configuring the CID layer as a third, outwardmost layer that covers the second layer and provides notification of intrusion attempts into the second layer.

14. The method of claim 13, further comprising coupling the processor to the third layer to detect attempts to access the second layer and affects functionality of the device when an attempt to access the second layer is detected.
